(19) United States
(12) Patent Application Publication
(10) Pub. No.: US 2007/0242152 A1
(43) Pub. Date: Oct. 18, 2007

(54) Auto-focus imaging system

(75) Inventor: Ga-Lane Chen, Fremont, CA (US)

Correspondence Address: PCE INDUSTRY, INC.;ATT. CHENG-JU CHIANG JEFFREY T. KNAPP, 458 E. LAMBERT ROAD, FULLERTON, CA, 92835, US

(73) Assignee: HON HAI PRECISION INDUSTRY CO., LTD., Tu-Cheng (TW)

(21) Appl. No.: 11/309,900

(22) Filed: Oct. 24, 2006

(30) Foreign Application Priority Data
Apr. 12, 2006 (CN) 200610060266.0

(51) Int. Cl. G03B 13/00

(52) U.S. Cl. 348/345

(57) ABSTRACT

An exemplary auto-focus imaging system having a compact configuration and a high-focusing accuracy includes a lens assembly, an image sensor, a locator, a control unit, and a voice coil actuator. The lens assembly is configured for picking up and manipulating optical information. The image sensor is configured for sensing the optical information and producing corresponding electronic signals. The locator is configured for producing a first position signal representative of an actual position of the lens assembly. The locator includes a magnet and a magnetic sensor. A relative positional relationship between the magnet and the magnetic directly varies with a movement of the lens assembly. The control unit is configured for receiving the electronic signals and the first position signal and outputting a control signal. The voice coil actuator is configured for receiving the control signal and moving the lens assembly to a desired position.

### FIELD OF THE INVENTION

The present invention relates generally to the optical imaging field and, more particularly, to imaging systems having an auto focus function.

### DESCRIPTION OF RELATED ART

Auto-focus techniques have been widely employed in various imaging systems, including, e.g., still camera systems and video camera systems. Nowadays, there are basically two main auto-focus methods: one is an active focus (i.e., distance metering) method, and the other one is a passive focus (i.e., focus detecting) method. In particular, the passive focus method mainly employs a charge-coupled device (CCD) and works by evaluating the amount of contrast or the phase difference in a scene. The active focus method usually utilizes an infrared light or ultrasound emitter and a corresponding receiver in a triangular surveying system, the data generated thereby being converted by a microprocessor (e.g., a well-known digital signal processor) into information about distance and thereby enabling the automatic focusing within an auto-focus imaging system.

Generally, a digital auto-focus camera system includes an optical imaging assembly, an image sensor (e.g., charged-coupled device or complementary metal oxide semiconductor device), a control unit (e.g., a digital signal processor or an image signal processor), and an actuator. The optical imaging assembly usually includes a movable lens assembly. The actuator commonly includes a stepper motor and a drive circuitry. The drive circuitry, regulated by the control unit, can drive the stepper motor to perform a rotational movement. In order to carry out the position adjustment of the movable lens assembly in an automatic focusing process, a gear assembly has necessarily been employed in the lens movement system to transform the rotational movement of the stepper motor into linear movement. However, the existence of the gear assembly generally renders the lens positioning system unduly bulky. Furthermore, the occurrence of backlash/recoil in the gear assembly will usually result in a degraded focusing accuracy.

What is needed is to provide an auto-focus imaging system having a compact configuration and a relatively high focusing accuracy.

### SUMMARY OF THE INVENTION

A preferred embodiment provides an imaging system (e.g., a digital still or video camera) with an auto-focus function. The imaging system includes a lens assembly, an image sensor, a locator, a control unit, and a voice coil actuator. The lens assembly is configured (i.e., structured and arranged) for picking up optical information representative of a target and optically manipulating (e.g., focusing) such optical information. The image sensor is configured for detecting the optical information and producing electronic signals corresponding to the optical information. The locator includes a magnet and a magnetic sensor. A relative positional relationship between the magnet and the magnetic sensor varies in conjunction with a movement of the lens assembly. The magnetic sensor is configured for sensing the relative positional relationship and generating a first position signal representative of an actual position of the lens assembly. The control unit is configured for receiving both the electronic signals from the image sensor and the first position signal from the magnetic sensor, generating a second position signal representative of a desired position of the lens assembly based on the electronic signals, and producing a control signal based on the first position signal and the second position signal. The voice coil actuator is configured for receiving the control signal from the control unit and driving the lens assembly to the desired position under the control of the control signal.

The imaging system, in accordance with the preferred embodiment, by incorporating the locator and the voice coil actuator therein, can achieve a compact configuration and a relatively high focusing accuracy. This compactness and accuracy is possible because that the locator including a magnet and a magnetic sensor can accurately sense an actual position of the lens assembly of the lens system and signal such a position to the control unit; and the voice coil actuator can cause a direct linear movement of the lens assembly, under the operation of the control unit. Accordingly, such accurate movement can be achieved without the need of the conventional gear assembly and, thereby, with no occurrence of backlash therein. As such, the present imaging system, having a compact configuration and a relatively high focusing accuracy, can be obtained, resulting from the cooperative nature of the locator and the voice coil actuator.

Other advantages and novel features will become more apparent from the following detailed description of embodiments when taken in conjunction with the accompanying drawings.

### BRIEF DESCRIPTION OF THE DRAWINGS

Many aspects of the present imaging system can be better understood with reference to the following drawings. The components in the drawings are not necessarily drawn to scale, the emphasis instead being placed upon clearly illustrating the principles of the present imaging system. Moreover, in the drawings, like reference numerals designate corresponding parts throughout the several views.

FIG. 1 is a schematic, cut-away view of an imaging system with an auto-focus function, in accordance with a preferred embodiment, the imaging system including a locator employing a magnet and a magnetic sensor;

FIG. 2A shows an initial relative positional relationship between the magnet and the magnetic sensor of FIG. 1;

FIG. 2B shows another relative positional relationship between the magnet and the magnetic sensor of FIG. 1, the magnet being displaced/shifted a distance relative to the magnetic sensor;

FIG. 2C shows another relative positional relationship between the magnet and the magnetic sensor, in accordance with another preferred embodiment, the magnet being rotated an angle relative to the magnetic sensor;

FIG. 3 is a simplified functional block diagram of the imaging system of FIG. 1; and

FIG. 4 is a schematic, cut-away view of an imaging system, in accordance with further another preferred embodiment.

The exemplifications set out herein illustrate various preferred embodiments, in various forms, and such exemplifications are not to be construed as limiting the scope of the present imaging system in any manner.

### DETAILED DESCRIPTION OF THE INVENTION

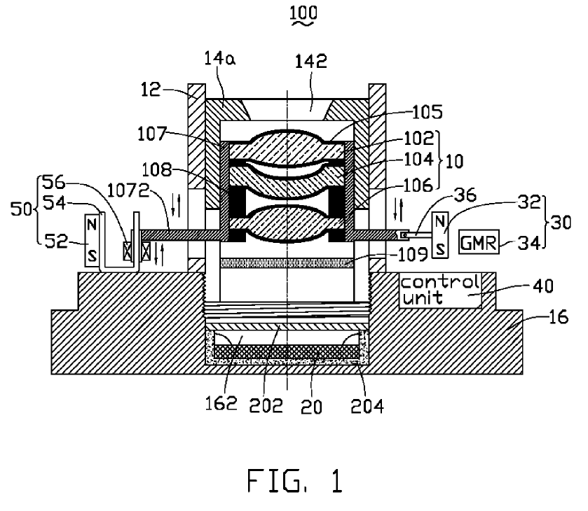

Referring to FIG. 1, an imaging system 100 with an auto-focus function, in accordance with a preferred embodiment, is provided. The imaging system 100 includes: a movable lens assembly 10, an image sensor 20, a locator 30, a control unit 40, and a voice coil actuator 50.

The movable lens assembly 10 is configured (i.e., structured and arranged) for picking up optical information representative of a target (e.g., a person) and manipulating (e.g., selectably focusing) such optical information. It is understood that the manipulation could further include, for example, diffraction and/or color filtration. The movable lens assembly 10 is linearly movable along guiding members 12 in order to facilitate a change in a back focal length thereof. The guiding members 12 each define a guiding slot (not labeled), extending along a direction substantially parallel to the optical axis of the lens assembly 10, as denoted by the dotted and dashed line in FIG. 1. The lens assembly 10 includes at least one lens, e.g. lenses 102, 104 and 106. The lenses 102, 104 and 106 are held together by mean of a fixture 107, and two adjacent lenses thereof are separated from each other via a ring-shaped spacer 108. Each of the lenses 102, 104 and 106 can be made, e.g., of a transparent optical material such as glass or plastic. Preferably, each of the lenses 102, 104 and 106 is an aspherical lens, and each two opposite lens surfaces of a given lens 102, 104 and 106 are respectively coated with an anti-reflective film 105. The fixture 107 usually has at least two extension portions 1072 extending along a direction substantially perpendicular to the optical axis of the lens assembly 10.

The movable lens assembly 10, the fixture 107, and the spacers 108 are suitably received in a cylindrical lens barrel 14a. The lens barrel 14a has a truncated-cone-shaped through hole 142 defined therein, the through hole 142 being located at an object side of the lens assembly 10. Light (i.e., optical information) reflected from a target can pass through the through hole 142 and strike, in order, on the lenses 102, 104 and 106 of the lens assembly 10. The lens barrel 14a defines at least two barrel slots (not labeled) in its sidewall. The at least two barrel slots each have a suitable length dimension, thereby facilitating the movement of the extension portions 1072 of the fixture 107 and the consequent adjusting of the back focal length of the lens assembly 10. It is understood to one of ordinary skill in the art that another suitable optical element, such as a filter 109 (e.g., infrared cut filter) located at the image side of the lens assembly 10, also can be received and fixed in the lens barrel 14a, to further improve the operational stability of the imaging system 100.

As shown in FIG. 1, the cylindrical lens barrel 14a is advantageously threadedly attached to and, thereby, held by a holder 16. As such, the lens barrel 14a always is kept stationary, during an automatic focusing process of the imaging system 100. In particular, the lens barrel 14a has an external thread adjacent to the image side of the lens assembly 10. The holder 16 defines an opening 162 therein and has an internal thread matching with the external thread of the lens barrel 14a. Therefore, the external thread of the cylindrical lens barrel 14a can be screwed into the opening 162 of the holder 16, and thereby the lens barrel 14a can be held by the holder 16.

The image sensor 20 is configured for detecting the optical information picked up by the lens assembly 10 and producing electronic signals corresponding to the optical information. The image sensor 20 is usually disposed at the image side of the lens assembly 10. The image sensor 20 can be a CCD (charge-coupled device) active pixel array device or another suitable sensor, e.g., a CMOS (complementary metal oxide semiconductor) active pixel array device. A CCD active pixel array device and a CMOS active pixel array device each generally include a two-dimensional pixel array. Suitably, the image sensor 20 is received in the opening 162 of the holder 16 and supported by a ceramic substrate 204. The ceramic substrate 204 also is received in the opening 162. Advantageously, in order to protect the image sensor 20 from contamination, a transparent cover 202 (e.g., a glass plate) is employed and received in the opening 162 to cover the image sensor 20.

The locator 30 is configured for sensing actual positions of the movable lens assembly 10. In particular, the locator 30 includes a magnet 32 and a magnetic sensor 34. The magnet 32 can be a permanent magnet or an electromagnet. A relative positional relationship between the magnet 32 and the magnetic sensor 34 correspondingly varies in conjunction with a linear movement of the lens assembly 10 along the guiding members 12. For example, the magnet 32 and the magnetic sensor 34 are rotatable or displaceable relative to each other, in conjunction with the linear movement of the lens assembly 10. The magnetic sensor 34 can be used to sense the relative positional relationship between the magnet 32 and the magnetic sensor 34 and generate/produce a first position signal representative of an actual position of the lens assembly 10.

In the illustrated embodiment, the magnet 32 is connected to one extension portion 1072 of the fixture 107 via a connection member 36. In particular, one end of the connection member 11 is fixed on the magnet 32, and the other opposite end thereof is fixedly or rotatably connected with the extension portion 1072. The magnetic sensor 34 is disposed opposite to the magnet 32. The magnetic sensor 34 is advantageously a giant magneto-resistive (GMR) sensor, as shown in FIG. 1. Generally, the GMR sensor is sensitive to the direction of the magnetic field. This directional dependence of the resistance resembles a cosine function and is therefore nearly linear within a wide range. As such, the GMR sensor can facilitate the provision of the actual position of the lens assembly 10 with a high accuracy. It is understood that the magnetic sensor 34 can be another suitable magnetic sensor, such as an anisotropic magneto-resistive (AMR) sensor.

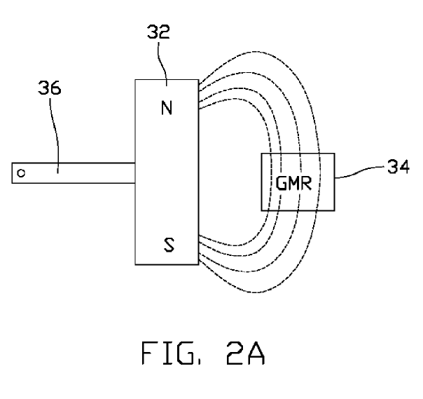

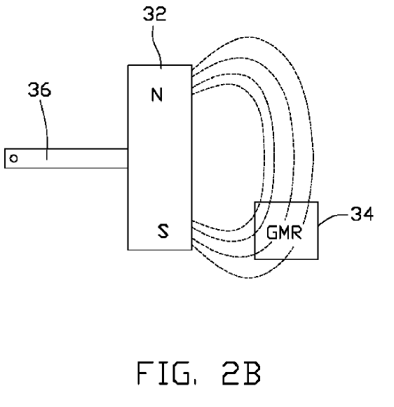

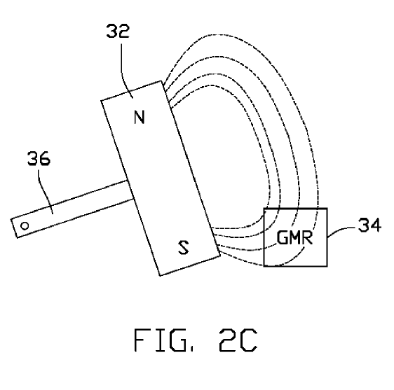

Referring to FIG. 2A through 2C, FIG. 2A shows an initial relative positional relationship between the magnet 32 and the magnetic sensor 34. The magnet 32 generates a number of magnetic lines of force penetrating through the magnetic sensor 34. The magnetic sensor 34 can output a first position signal representative of the current actual position of the lens assembly 10 via sensing the direction of the magnetic lines of the force acting thereon. When the magnet 32 is fixedly connected to the extension portion 1072, and the magnet 32 shifts/displaces a distance relative to the magnetic sensor 34 in direct conjunction with a linear movement of the lens assembly 10, as shown in FIG. 2B, the directions of the magnetic lines of the force acting on the magnetic sensor 34 are different from that of the initial state, as mentioned above. At this time, the magnetic sensor 34 can produce/generate another first positional signal (usually, an analogue signal) representative of another actual position of the lens assembly 10, via sensing the direction of magnetic lines of force acting thereon. Alternatively, the magnet 32 is rotatably connected to the extension portion 1072, and the magnet 32 thus can rotate an angle relative to the magnetic sensor 34, in direct conjunction with a linear movement of the lens assembly 10, as shown in FIG. 2C. Likewise, the magnetic sensor 34 can output a first position signal representative of the actual position of the lens assembly 10, via sensing the direction of magnetic lines of the force acting thereon.

The control unit 40 is configured for signaling a control signal to the voice coil actuator 50 and for, accordingly, driving the lens assembly to any desired position to achieve an appropriate focus. The control unit 40 is electrically connected with the image sensor 20, the magnetic sensor 34 of the locator 30, and the voice coil actuator 50. The control unit 40 can, e.g., be any suitable and well-known digital signal processor (DSP) or image signal processor (ISP).

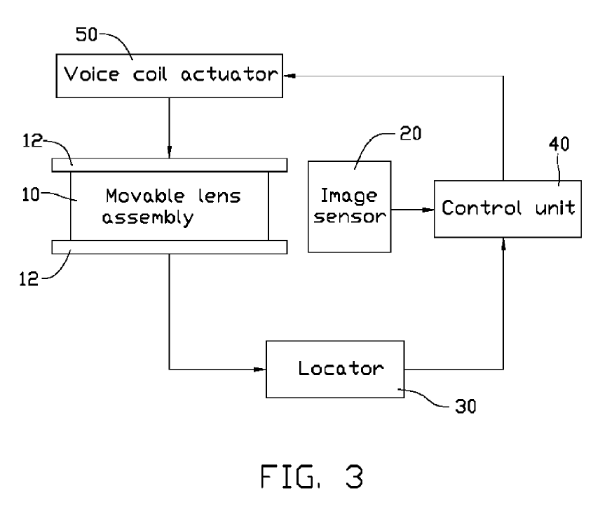

In particular, as shown in FIG. 3, the control unit 40 receives the electronic signals from the image sensor 20 and a first position signal from the magnetic sensor 34. The first position signal can, advantageously, be processed via an amplifier (not shown) before being sent to the control unit 40. Subsequently, the control unit 40 generates a second position signal representative of a desired position of the lens assembly 10, based on the electronic signals. The control unit 40 then compares the first position signal representative of the actual position, with the second position signal representative of the desired position and thereby then produces/generates a control signal representative of a position difference between the actual position and the desired position. The control signal produced/generated from the control unit 40 will be sent to the voice coil actuator 50.

The voice coil actuator 50 is configured for receiving the control signal from the control unit 40 and linearly moving the lens assembly 10 to the desired position, based on the control signal. As illustrated in FIG. 1, the voice coil actuator 50 includes a permanent magnet 52, a yoke 54, and a coil 56. The yoke 54 suitably has a U-shape and two opposite ends each extending along a direction substantially parallel to the optical axis of the lens assembly 10. The permanent magnet 52 is fixed on one end of the yoke 54, and the coil 56 is movably connected with the other one end of the yoke 54. The coil 56 is mechanically engaged with the lens assembly 10 by being connected with the extension portion 1072 of the fixture 107.

When the control signals from the control unit 40 are sent to the voice coil actuator 50, a flow of current through the coil 56 will vary. A variation in the current through the coil 56 will cause a change in the magnetic flux created by the coil 56, thereby resulting in an electromagnetic force between the coil 56 and the permanent magnet 52. Since the yoke 54 is being held stationary by the permanent magnet 52, the coil 56 will linearly move with respect to the yoke 54 along directions denoted by the arrows in FIG. 1. This linear movement of the coil 56 will be transmitted to the lens assembly 510 via one extension portion 1072 of the fixture 107, and thereby the lens assembly 10 will carry out a synchronous linear movement. In addition, the magnet 32 will be displaced/shifted or rotated relative to the magnetic sensor 34, in conjunction with the linear movement of the lens assembly 10, due to the force transmission function of the extension portion 1072 connected with the magnet 32 (i.e., a desired change in the location of the first position occurs).

Alternatively, a combination of the coil 56 being stationary with the permanent magnet 52 being selectably movable also can achieve the purpose of driving the lens assembly 10 to move to a desired position. In particular, the coil 56 is fixed on and surrounds a rod-like (i.e., rod-shaped) yoke 54, while the permanent magnet 52 is fixedly connected with the extension portion 1072 of the fixture 107, rather than the rod-like yoke 54. The permanent magnet 52 is disposed opposite to and apart from the coil 56. When a variation in the current through the coil 56 occurs, since the coil 56 is being held stationary, the permanent magnet 52 will linearly move with respect to the coil 56 along directions denoted by the arrows in FIG. 1.

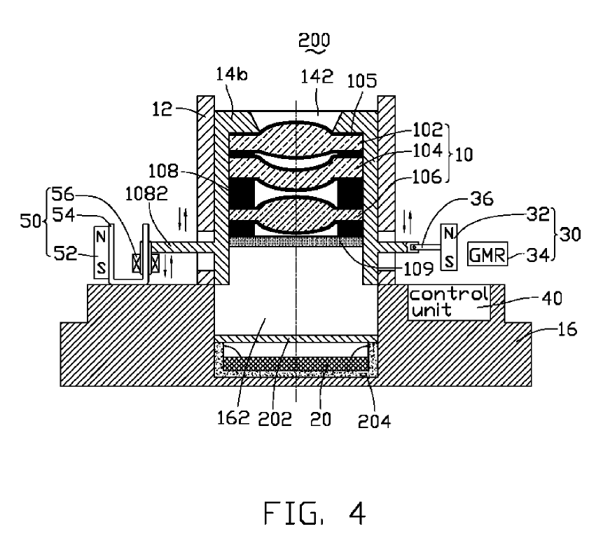

Referring to FIG. 4, an imaging system 200 with an auto-focus capability, in accordance with another preferred embodiment, is provided. The imaging system 200 has a structure similar to that of the imaging system 100, as mentioned above. The imaging system 200 also includes: a movable lens assembly 10, an image sensor 20, a locator 30, a control unit 40, and a voice coil actuator 50, like the imaging system 100. However, the imaging system 200 also has other different structures, as follows: the lens assembly 10 is directly received in and held by the cylindrical lens barrel 14b without the need of being held by the above-mentioned fixture 107. As such, the cylindrical lens barrel 14b usually carries out a linear movement, during an auto-focus process of the imaging system 20. Correspondingly, the lens barrel 14b is configured without an external thread like the lens barrel 14a, as mentioned above. Furthermore, the lens barrel 14b, similar to the fixture 107, also has at least two extension portions 1082 each extending along a direction substantially perpendicular to the optical axis of the lens assembly 10. The extension portions 1082 of the lens barrel 14b are connected with the connection member 36 and the coil 56 (as illustrated in FIG. 4), correspondingly, and thereby performing functions similar to the extension portion 1072 of the fixture 107, as mentioned above.

Alternatively, the extending member 1082 connected with the coil 56 can be connected to the permanent magnet 52 instead, under the situation of the coil 56 being stationary with the permanent magnet 52 being movable, as described above.

In sum, the auto-focus imaging systems 100, 200, as described above, in accordance with preferred embodiments, each employs a locator 30, including a magnet 32 and a magnetic sensor 34, and a voice coil actuator 50 therein. The unique configuration of the locator 30 facilitates the actual position of the lens assembly 10 being highly accurately measured and thus provided to the control unit 40. The voice coil actuator can cause a direct linear movement to move the lens assembly 10 of the imaging system 100 or 200, under the accurate control of the control unit 40, without the need of the conventional gear assembly and thereby no potential for occurrence of backlash within such a gear assembly. As such, the auto-focus imaging systems 100, 200 each readily achieve a compact configuration and a relatively high focusing accuracy, resulting from the cooperative workings of the locator 30 and the voice coil actuator 50.

It is believed that the present embodiments and their advantages will be understood from the foregoing description, and it will be apparent that various changes may be made thereto without departing from the spirit and scope of the invention or sacrificing all of its material advantages, the examples hereinbefore described merely being preferred or exemplary embodiments of the present invention.

What is claimed is:

1. An auto-focus imaging system, comprising:
a lens assembly configured for picking up optical information representative of a target and selectably manipulating the optical information;
an image sensor configured for detecting the optical information and producing electronic signals corresponding to the optical information;
a locator including a magnet and a magnetic sensor, a relative positional relationship between the magnet and the magnetic being configured for correspondingly varying with a movement of the lens assembly, the magnetic sensor being configured for sensing the relative positional relationship and generating a first position signal representative of an actual position of the lens assembly;
a control unit configured for receiving both the electronic signals from the image sensor and the first position signal from the magnetic sensor, generating a second position signal representative of a desired position of the lens assembly based on the electronic signals, and outputting a control signal by way of comparing the first position signal with the second position signal; and
a voice coil actuator configured for receiving the control signal from the control unit and driving the lens assembly to the desired position based on the control signal.

2. The auto-focus imaging system of claim 1, wherein the magnet is one of a permanent magnet and an electro-magnet.

3. The auto-focus imaging system of claim 1, wherein the magnetic sensor is one of a giant magneto-resistive sensor and an anisotropic magneto-resistive sensor.

4. The auto-focus imaging system of claim 1, wherein the voice coil actuator comprises a permanent magnet and a coil, one of the permanent magnet and the coil being movable and the other one being kept stationary, the movable one of the permanent magnet and the coil being mechanically engaged with the lens assembly and thereby configured for driving the lens assembly to the desired position.

5. The auto-focus imaging system of claim 4, wherein the lens assembly comprises at least one lens and a fixture, the fixture configured for holding the at least one lens, the fixture including a first extension portion and a second extension portion, each of the first extension portion and the second extension portion extending along a direction substantially perpendicular to an optical axis of the lens assembly, the first extension portion being connected with the movable one of the permanent magnet and the coil for mechanically engaging the movable one of the permanent magnet and the coil with the lens assembly, the second extension portion being connected with one of the magnet and the magnetic sensor for mechanically engaging the locator with the lens assembly.

6. The auto-focus imaging system of claim 5, wherein the magnet and the magnetic sensor are at least one of displaceable and rotatable relative to each other in direct conjunction with the movement of the lens assembly and thereby causing the relative positional relationships between the magnet and the magnetic sensor to change accordingly.

7. The auto-focus imaging system of claim 6, wherein the second extension portion is connected with the magnet, the magnet and the magnetic sensor being located apart from each other.

8. An auto-focus imaging system, comprising:
a lens assembly configured for picking up optical information representative of a target and manipulating the optical information;
an image sensor configured for detecting the optical information and producing electronic signals corresponding to the optical information;
a locator including a magnet and a magnetic sensor, a relative positional relationship between the magnet and the magnetic being configured for correspondingly varying with a movement of the lens assembly, and the magnetic sensor being configured for sensing the relative positional relationship and then producing a first position signal representative of an actual position of the lens assembly;
a control unit configured for receiving both the electronic signals from the image sensor and the first position signal from the magnetic sensor, producing a second position signal representative of a desired position of the lens assembly based on the electronic signals, and producing a control signal based on the first position signal and the second position signal; and
a linear actuator configured for receiving the control signal from the control unit and accordingly generating a linear motion to drive the lens assembly to the desired position under the control of the control signal.

9. The auto-focus imaging system of claim 8, wherein the linear actuator comprises a permanent magnet and a coil disposed opposite to the permanent magnet, one of the permanent magnet and the coil being movable and the other one being kept stationary, the movable one of the permanent magnet and the coil being mechanically engaged with the lens assembly and thereby configured for driving the lens assembly to the desired position.

10. The auto-focus imaging system of claim 8, wherein the magnet and the magnetic sensor are at least one of displaceable and rotatable relative to each other in direct conjunction with the movement of the lens assembly, and thereby causing the relative positional relationships between the magnet and the magnetic sensor to change accordingly.

11. The auto-focus imaging system of claim 10, wherein the magnet and the magnetic sensor are disposed apart from each other, one of the magnet and the magnetic sensor being mechanically engaged with the lens assembly.

12. The auto-focus imaging system of claim 8, wherein the magnet is one of a permanent magnet and an electro-magnet.

13. The auto-focus imaging system of claim 11, wherein the magnetic sensor is one of a giant magneto-resistive sensor and an anisotropic magneto-resistive sensor.
